(19) United States
(12) Patent Application Publication
(10) Pub. No.: US 2011/0259829 A1
(43) Pub. Date: Oct. 27, 2011

(54) METHOD FOR REMOVING BORON IN WATER TREATMENT

(75) Inventor: Francisco Javier Mujal Valls, Barcelona (ES)

(73) Assignee: Air Water Treatment S.L., Vilanova la Geltru (ES)

(21) Appl. No.: 12/673,065

(22) PCT Filed: Jul. 7, 2008
(86) PCT No.: PCT/ES08/00479

§ 371 Date: Jul. 14, 2011

(30) Foreign Application Priority Data
Aug. 14, 2007 (ES) P200702281

(51) Int. Cl. C02F 1/28; C02F 101/10

(52) U.S. Cl. 210/670; 210/660; 210/679

(57) ABSTRACT

The invention relates to a process for reducing boron levels in water comprising the steps of passing the water with boron through an inlet manifold, adding basic or alkaline additives, treating the water from the previous step with clays, removing the water from the previous step through an outlet manifold and washing the clays.

### TECHNICAL FIELD OF THE INVENTION

The invention is comprised in the field of water treatment and purification, specifically relating to a process for reducing the concentration of boron in water by means of using clays.

### STATE OF THE ART

Boron is a widely distributed element in the atmosphere, lithosphere and hydrosphere. Atmospheric boron is mostly in the form of gas and reaches the atmosphere by evaporation of seawater. In the lithosphere, it is mainly found in sedimentary rocks primarily due to its high affinity for clay minerals. In the hydrosphere, boron is in the form of boric acid, H₃BO₃, and borate ion, H₂BO₃—; the concentration of each of these forms varies according to the pH, both compounds being in equilibrium at a pH of 8.7 and 8.8.

Boron is also one of the essential micronutrients that living organisms need to develop. In animals, boron is an essential trace element for life and its intake in high concentrations causes alterations in the testicles. Furthermore, in humans, exposure to moderate concentrations of boron causes irritation of the mucous membranes and a reduced number of spermatozoids.

In plant organisms, boron is an essential trace element for growth and is involved in fundamental metabolic processes such as phenol metabolism and lignin synthesis. Boron deficiency inhibits plant development and an excess of this element is toxic. The range between deficiency and toxic levels is only 1 or 2 ppm, and any oscillation could cause significant physiological alternations in the plant.

Therefore, considering the importance of boron as an essential micronutrient in organisms and given the current importance of preserving the environment and the socioeconomic relevance of the food industry, it is essential to maintain optimal boron levels in irrigation water, where an excess of this element may be highly toxic for plants and for their consumers given that boron accumulates in plants, and is found in foods, mainly fruits and vegetables.

Excess boron in water may be due to the dumping of urban, industrial and chemical wastes used in agriculture. In potable water, the presence of boron is limited to 0.5 ppm, whereas in irrigation water, the optimal concentration of boron is between 0.3 ppm and 0.75 ppm, for sensitive crops a concentration of 1.0 ppm is considered limiting.

For the purpose of reducing boron levels in water, conventional methods have been developed such as the treatment with iron, salts, aluminum sulfate and lime. Patent WO9959187 describes a process for eliminating boron and fluoride ions from water by contacting water from the food source, in the presence of magnesium, with alkaline hydroxide to produce treated water and a magnesium precipitate containing boron and fluorine.

Another method used is reverse-osmosis, but it is ineffective since the borate ions cannot traverse the pores of the membranes used in reverse-osmosis systems.

The most widely used method for removing boron are ion exchange resins. Patent U.S. Pat. No. 3,856,670 describes a process for removing boron from water by contacting the aqueous solution containing borate ions with a water insoluble anionic ion exchange phenolic resin, in the presence of at least one cationic species selected from the group of alkali, alkaline earth, nitrogen organic bases and ammonium cations. Patent application ES2246705 describes a process for removing borate anion from aqueous media using sugars fixed to an inorganic type resin. In some cases, such as the one described in the document (Nadav, N., Boron removal from seawater reverse osmosis permeate utilizing selective ion exchange resin; Desalinization 124 (1999) 131-135), the ion exchange resin that is used is selective for boron.

In this case the limiting factor of the process is the pH of the water, since at pH values of less than 8, boron in aqueous phase is in the form of boric acid and the exchange of this element with the corresponding resin does not occur, thereby reducing the yield from 95% to 65%. Generally, using ion exchange resins to remove boron from water is ineffective since they are too expensive or cannot be applied at low concentrations, or they are not specific enough in the presence of other interfering ion species and/or organic contaminants.

### DESCRIPTION OF THE INVENTION

In view of the foregoing, it is necessary to develop new techniques which allow effectively removing boron from water without the drawbacks of the techniques used today. The invention describes a process for removing boron from water by means of using clays, since their high specific area, their high porosity and their electric charge, clay particles are able to absorb water and other polar compounds as well as fix and exchange cations with the medium. This process is simpler, faster and less expensive than those described in the current state of the art.

The invention relates to a process for removing boron in water treatment, comprising the following steps:

In a first step, stream of water to be treated passes through an inlet manifold.

Said water can reach the treatment in different ways: by gravity or by means of pumping.

The water to be treated can be freshwater or seawater, provided it is contaminated with boron.

The water can be at different pH levels depending on its origin. Regardless of the pH level at the origin of the water to be treated with a boron content, the water to be treated will be subjected to pH correction and/or conditioning by means of basic or alkaline additives only when the inlet water has a pH of less than 5.5.

In the event that seawater is treated by means of the process described in the invention, the pH in its natural state is approximately 8.2, i.e., the boron is in the form of boric acid and has a boron concentration between 4 and 5 mg/l. Boron begins to be transformed into borate ion at a pH of 9.5, and only after a pH of 12 is 100% of the boron in the water in the form of borate ion.

Once the water to be treated has been conditioned, the water is contacted with the expanded clays present in the filter.

Said filter can be, by way of a non-limiting example, a concrete tank, metallic or plastic material filter, either an open, closed or pressure filter.

The water is contacted with the clays either in the upwards direction, i.e., from bottom to top, or in contrast in the downwards direction, i.e., from top to bottom.

The expanded clays are of a size from 0.2 to 10 mm, the choice of the size depending on the boron load in the water to be treated, having a density of greater than 1.0 kg/liter since lower densities make the clay float, and with a porosity level of greater than 40%. In addition, filtration rates are comprised within the range between 5 and 15 m₃/h m₂ of filter surface area. The height of the support for the expanded clays housed inside the filter is comprised between 0.5 to 3 meters.

The boron is adsorbed into the clays, whereby reducing the boron concentration in the water.

The clays used for removing boron from water are preferably any of the clays described and known in the prior state of the art.

The process of retaining boron in clays occurs in two steps; in a first exothermic step, the boron is adsorbed on the outer particles of the clay by a mechanism of ligand exchange with hydroxyl groups, with the subsequent migration and integration thereof inside the tetrahedral sites, displacing the aluminum and silicon of the structure through a second slower endothermic fixation reaction.

Once the water has traversed the support for the clays, it is drained by gravity or by means of pumping.

In a fourth step, the water which is now boron-free due to the action of the clays used in the process is extracted. Therefore, by means of the process described in the invention, boron present in the water is removed by between 40 and 95%.

In a fifth step of the process for removing boron, a cycle for washing the expanded clays must be performed, which cycle will be performed every 24 or 72 hours and/or alternatively by pressure differential. The washing will be done using the treated water by means of a pumping system which will drive the water towards the filter in the upwards direction, i.e., from bottom to top, to achieve sufficient expansion of the clays which allow entraining the accumulated excess boron outside the system.

The clays need not be renewed for 20 to 25 years.

The process will preferably be carried out in water purification and regeneration plants.

The efficiency of the process described in the invention is from 40 to 80% removal of boron.

It is thus achieved that the described process has, in addition to the removal of boron, another series of advantages:

Turbidity of the water is reduced to values under 1 NTU (nephelometric turbidity unit).

Biodegradable organic and inorganic matter is removed, organic matter is trapped in the filters by a biological filtration process, whereby causing a consumption of oxygen present in the water while at the same time reducing TOC (total organic carbon).

### EMBODIMENT

Seawater is pumped into a contact chamber. Then the water is passed in a downwards direction, i.e., from top to bottom, and/or alternatively in an upward direction, i.e., from bottom to top, directly contacting the water to be treated with the expanded clays which are housed in a filter. The filtering cycle is carried out at rates comprised between 4 and 16 m₃/h m₂ and the height of the support for the clays is comprised between 0.5 and 3 meters.

The expanded clay used is high porosity clay, with a large specific surface area, having a size comprised between 0.2 and 10 mm and a density of greater than 1.0 kg/liter.

After the filtering process, the boron-free water is discharged into a treated water tank for its later use. Once the water filtering cycle has ended, the expanded clay filter is washed. To do this, the treated water is pumped in the upwards direction, i.e., from bottom to top, causing a slight expansion of the support for the clays in order to extract and drain the excess boron absorbed in the filtering process. The washing is carried out at filtering rates comprised between 15 and 30 m₃/h m₂ and the necessary washing time is comprised between 4 and 10 minutes. The washing frequency is comprised between 24 and 72 hours and/or it can alternatively be regulated by pressure differential. As a complement to washing with water, the washing can be carried out with air, air-water sequentially. Once the washing has been carried out, the clay filter is now fully able to begin a filtering process again, i.e., a process for removing boron from water to be treated.

1. A process for removing boron in water treatment, characterized in that it comprises at least, the following steps:
a) passing the water with boron through an inlet manifold;
b) adding basic or alkaline additives when the inlet water has a pH of less than 5.5;
c) treating the water from step b) with clays;
d) removing the water from step c) through an outlet manifold; and
e) washing the clays.

2. The process for removing boron in water treatment according to claim 1, characterized in that the water reaches the manifold by means of gravity or by means of pumping.

3. The process for removing boron in water treatment according to claim 1, characterized in that the water to be treated is freshwater or seawater.

4. The process for removing boron in water treatment according to claim 1, characterized in that said process is preferably carried out in water purification and regeneration plants.

5. The process for removing boron in water treatment according to claim 1, characterized in that the clays are expanded-type clays.

6. The process for removing boron in water treatment according to claims 1 and 5, characterized in that the clays are housed in filters.

7. The process for removing boron in water treatment according to claim 5, characterized in that the filters are concrete tank, metallic or plastic material-type filters, either open, closed or pressure filters.

8. The process for removing boron in water treatment according to claims 1 and 5, characterized in that the clays have a size from 0.2 up to 10 mm.

9. The process for removing boron in water treatment according to claim 1, characterized in that the clays have a density of greater than 1.0 kg/liter.

10. The process for removing boron in water treatment according to claim 1, characterized in that the porosity of the clays is greater than 40%.

11. The process for removing boron in water treatment according to claim 1, characterized in that the filtration rates range from 5 to 15 m₃/h m₂ of filter surface area.

12. The process for removing boron in water treatment according to claim 1, characterized in that the height of the support for the clays housed in the filters is comprised from 0.5 to 3 meters.

13. The process for removing boron in water treatment according to claim 1, characterized in that the water is drained by means of gravity or by means of pumping.

14. The process for removing boron in water treatment according to claim 1, characterized in that the clays are washed by means of water or a mixture of air/water sequentially every 24 to 72 hours and/or it can alternatively be regulated by pressure differential.

15. A use of the process for removing boron in water treatment according to any of claims 1 to 14 for water purification and regeneration.
